(19) United States
(12) Patent Application Publication
(10) Pub. No.: US 2022/0178564 A1
(43) Pub. Date: Jun. 9, 2022

(54) SYSTEM FOR TREATING AIR IN BUILDING INTERIORS, AND VENTILATOR DEVICE

(71) Applicant: MICHEL GILGES, KAARST (DE)

(72) Inventor: MICHEL GILGES, KAARST (DE)

(21) Appl. No.: 17/437,420

(22) PCT Filed: Mar. 9, 2020
(86) PCT No.: PCT/EP2020/056142

§ 371 Date: Feb. 22, 2022

(30) Foreign Application Priority Data
Mar. 12, 2019 (DE) 10 2019 106 264.0

(51) Int. Cl. F24F 7/06

(52) U.S. Cl. CPC F24F 7/06

(57) ABSTRACT

A system for treating air in a building interior. The system includes a ventilator module with a housing, a flow channel, a drive motor, and an impeller. The housing has upper face with at least one opening, an oppositely arranged lower face with a housing base which is designed as a stand surface for positioning the ventilator module, a housing wall extending between the upper face and the lower face, and a lateral outlet opening arranged on the housing wall in a region which is adjacent to the lower face. The flow channel is formed in the housing between the one upper face and the lower face. The drive motor is arranged in the housing. The at least one impeller rotates about a rotational axis and is driven by the drive motor to convey an air flow between the upper face and the lower face.

The invention relates to a system for treating air in building interiors, comprising at least one ventilator module, which comprises a housing with at least one upper face that has at least one opening and an opposite lower face that has at least one opening and a housing base, and a flow channel is formed in the housing between the upper face and the lower face, and at least one impeller which can be rotated about a rotational axis and can be driven by a drive motor is arranged in order to convey an air flow between the upper face and the lower face, in particular from the upper face through the housing in the direction of the lower face or from the lower face through the housing in the direction of the upper face. The invention also relates to a ventilator device.

Such air treatment systems that use a corresponding ventilator or ventilator module are known in various variants. Such systems are typically used for drying, for example, newly constructed or renovated building components, such as walls, ceilings or floors, in particular screed floors. Such systems are nowadays often used in existing buildings as well, for example, when there are damp basement walls. Such air treatment systems are used, in particular, to generate a specific room climate that is advantageous for drying purposes. The expression “for treating air” is to be understood, among other things, as setting the ambient air in motion, for example for air circulation purposes, in particular in the recirculation mode, to control the temperature of the ambient air or to regulate the humidity of the air. In this case, the system can comprise various components, even components that are known per se, such as the so-called air treatment units in the present case, which can, in particular, interact in a thermodynamic manner in order to treat the air.

Such system components can be, for example, an air-drying unit, which typically comprises a condenser and a fan for supplying the air via the condenser and is used to remove moisture from the ambient air, and/or an air heating unit, which typically comprises a heating device and a fan for conveying the air to or through the heating device and which is used to heat the ambient air.

In particular, due to the air conditions that are often present at construction sites, in particular dusty air, it has been found that the movable parts of such an air treatment unit, in particular the fan, generally limit the service life of the respective unit. In particular, the fan wheel may come into contact with or rub against a fan housing, or the fan wheel may break, which significantly reduces the efficiency and effectiveness of this air treatment unit and ultimately of the entire system for treating air. A continuous monitoring of the system and the system components is therefore required, which is typically carried out by staff on site and is therefore usually relatively cost-intensive. Furthermore, a rapid elimination of the error is desirable in such a case. Since the fan is usually fixedly installed in the air treatment unit, the entire air treatment unit is usually replaced with another air treatment unit in order to continue the air treatment quickly. In order to avoid a delay in or a stoppage of the air treatment, an additional replacement device is therefore usually kept on hand. This is particularly costly as well, however. Furthermore, an increased transport effort is required to exchange the devices, which leads to further disadvantages, which are also explained in detail below. In particular, due to their structure, such air treatment units are usually relatively large and heavy; therefore, such units can only be handled, moved and transported with a certain amount of effort. The units are therefore typically mounted on rollers, which can only be useful if the floor is level, but this is not the case, for example, when climbing stairs.

To use them as a cooperating system, the aforementioned system components, typically an air-drying unit, an air heating unit and a separate ventilator for the circulation of the ambient air, are installed and operated in a building room to be treated. These system components usually each form a stand-alone unit and work toward a common goal in a common operation or system, namely the achievement of a certain room climate, but only make a contribution to or have a share in the overall result. In particular, such system components are typically constructed, i.e., produced and designed, separately and are each operated individually and independently of one another. Furthermore, each system component is generally only designed to be switched on or off but is not controllable so that it can make the maximum possible contribution to the overall system. As a result, however, there may be performance differences between the individual system components in an operating system, which can significantly limit the effectiveness of the overall system. In particular, the ultimate effect, i.e., the achievement of a certain room climate, can be determined by the performance of the “weakest” system component. In the event of a fault or defect in an individual component such as the fan of an air treatment unit, this can lead to a total system failure with regard to the ultimate effect. For this reason too, it is necessary to always and continuously monitor the system and the system components.

In addition, such a system, which consists of a plurality of separate and independent individual components, requires a relatively large amount of space and transport effort. In particular, there must be a suitable place for each component both at the facility of the owner, which may be a device rental company, for storing the units and at a respective installation site, so that the unit can be used and operated at a predefined distance from the building wall and/or another system component. When transported, for example, from the owner to a construction site or from one construction site to another construction site, each system component must be transported to a respective room in a building integrally, i.e., as a whole, usually first on a vehicle and at the respective construction site by hand, usually via a stairwell. As already mentioned above, such uniform system components are relatively large and heavy and therefore require a relatively high expenditure of effort to be transported. This can be very tedious and complicated, especially in the case of relatively tall buildings or construction sites without a construction crane. It is not uncommon for devices to be damaged and/or persons to be injured in accidents, especially when the devices are transported by hand. The space requirement as well as the portability of the system components are therefore becoming an increasingly important aspect in the selection of the system components, both when, for example, a device rental company purchases such a device and when an order is placed, in particular by an injured party or an insurer.

Various ventilators that can be used in a system and that are designed as stand-alone or floor-standing or floor units are known for air circulation purposes. Such ventilators are used, in particular, for circulating or moving air within a room in order to be able to generate a uniform and homogeneous climate in a room as quickly as possible. Depending on the need or requirement for air treatment, such ventilators can be operated with or without an additional exchange of the ambient air, for example, by a concurrent ventilation of the room.

The impeller, also called an impeller wheel, is usually designed as a ring with blades for an axial or radial air conveyance. In the case of the ventilators provided for the present application, the ventilator housing is mostly designed in the form of a grid and consequently does not form a closed flow channel. As a result, however, side-flow effects can occur in the known ventilators, which can negatively affect the orientation and speed of the air flow and thus the efficiency of the ventilator and/or the entire air treatment system, especially with regard to a desired, directed air flow that is completely circulating in a room.

In most of the known ventilators, the ventilator housing, which comprises the upper face and the lower face, and the impeller arranged therein are usually rotatably mounted about a further axis relative to a frame structure so that the direction of the air mass driven by the ventilator can be adjusted about an axis at least relative to the frame structure. For this purpose, a corresponding mounting of the housing on a support structure is usually provided with a correspondingly increased manufacturing and space requirement being necessary for this purpose.

It should be clear that, in the present case, the respective terms “lower face” and “upper face” are not only to be understood to refer to the corresponding side in terms of area or to the corresponding surface of the respective side of the ventilator module but rather to a region or portion of the housing facing this surface, which can extend in the direction of the height of the housing up to the middle of the housing. The openings mentioned in this regard can consequently be arranged both on the upper or the lower end face of the housing and in one or more side walls of the housing in the respective upper or lower region.

The object of the present invention is therefore to provide an improved system for treating air in building interiors which addresses at least one of the above-mentioned disadvantages and, in particular, allows for a convenient portability and quick and effective air treatment. Furthermore, an improved ventilator device is to be provided which, in particular, allows for an air flow suitable for air treatment.

According to the invention, it is provided that the housing base is designed as a stand surface for setting up the ventilator module, in particular, on a building floor or on a building component. In particular, the lower face of the housing can form a housing base for the ventilator module in an operating state of the ventilator module, i.e., when the module is being operated. The housing base, also called the housing stand surface, and thus also the entire ventilator module housing, which comprises the upper face and the lower face, can consequently form the support structure of the ventilator so that an additional support structure is not required. As a result, the ventilator module can be constructed in a particularly space-saving and cost-effective manner. The housing base can, in particular, form a stand surface or a stand for the ventilator and can, in particular, be formed by the end surface on the lower face. It can be provided in this regard that when the ventilator is in operation, the housing base does not necessarily have to be in contact with a floor of the room but rather—with an appropriate arrangement—can also be in contact with a wall surface or a ceiling of the room. The ventilator module can, for example, be used as a floor-standing device in which the ventilator module with the housing base stands on a floor, and the stand surface or contact surface is aligned substantially horizontally as a ceiling device in which the ventilator module is fastened to a building ceiling with a fastening, and the contact surface is likewise aligned substantially horizontally or is alternatively operated as a wall device in which the housing base rests against a vertical or inclined building wall, for example, and the contact surface is oriented substantially vertically or in an inclined manner. When using the ventilator module, the support or contact surface does not necessarily have to be aligned horizontally; furthermore, the side of the ventilator module housing referred to as the lower face is not always necessarily the side of the housing facing downward in the direction of the room.

The rotational axis of the impeller is preferably aligned substantially perpendicular to the stand surface of the ventilator module formed by the housing base. In particular, the flow channel formed between the upper face and the lower face can have a flow axis or center line that extends from the upper face to the lower face and is oriented in its course, in particular in the region of the impeller, substantially perpendicular to a stand surface formed by the housing. According to the invention, the design of the ventilator module, which is also referred to as the ventilator device or ventilator, can, in particular, generate an air flow that is advantageously oriented for the treatment of air in a building interior. A particularly uniform and homogeneous air flow can, in particular, be generated in a building interior by aligning the air intake in the fan, the air acceleration in the flow channel and the subsequent air outflow from the ventilator in a building interior. The flow channel is preferably formed by a circumferential side wall of the housing which surrounds the impeller in at least one portion. As a result, the ventilator module can have a particularly high degree of efficiency and can be manufactured inexpensively. Furthermore, due to the defined design and alignment of the flow course in relation to the ventilator, a homogeneous air flow in a respective building interior can be reproduced in a particularly uncomplicated manner, i.e., always in the same manner, in that such a ventilator module is suitable for integration into an overall air treatment system, which may comprise further components or air treatment units. The ventilator according to the invention can always be integrated or tied into an overall system in the same way so that the effectiveness and efficiency of the overall system can be permanently constant and substantially the same for each use.

When the ventilator is operated as a floor-standing device, the flow axis formed by the flow channel in the ventilator can be aligned, in particular, in the vertical direction of the room so that when the ventilator module is arranged in the center of the room, the air flowing out of the ventilator module on the lower face or the upper face can be distributed throughout the room in a particularly uniform and homogeneous manner. The air flow can flow out on the lower face of the ventilator module, for example, and be guided at least across a certain region of the floor of the room. This is particularly advantageous for drying a building floor and for circulating all the air in the building interior. When the ventilator is operated as a wall unit, the flow axis in the ventilator can be aligned in the horizontal direction of the room. The air flowing out on the lower face of the ventilator facing the building wall can flow along this building wall in a particularly uniform manner and across a large surface, which is particularly advantageous for circulating air in the region of the wall, in particular for drying the wall.

In a preferred embodiment of the invention, the system additionally comprises an air treatment unit, and the ventilator module can preferably be attached to the air treatment unit. This makes it possible, in particular, that, for example, in the event of a power loss, fault or defect in the ventilator, only the ventilator module, which is particularly lightweight compared to an air treatment unit and therefore relatively easy to handle, can be replaced in a particularly simple manner. The air treatment unit as such may only comprise a single portion provided for the treatment of the air, for example, to control the temperature or to regulate the humidity of the air. This means that the air treatment unit can, in particular, be designed without a fan, and the ventilator module can form the fan for conveying the air into, to or through the air treatment unit. For this purpose, the air treatment unit can, in particular, comprise an air inlet and an air outlet and serve to treat or change the air flowing through the unit from the air inlet to the air outlet, in particular with regard to its properties such as temperature and humidity. The air can, for example, be cooled, heated, dried or humidified by means of the air treatment unit. The air treatment unit can, for example, be designed as a cooling module, generally also called a drying or condensation module, which can cause moisture to be extracted from the air flowing through the air treatment unit. In particular, the ventilator module can serve to move the air through the air treatment unit. The ventilator module can thus also form an additional part of the air treatment unit. Particularly preferably, a lower face of the air treatment unit can be placed on the upper face of the ventilator module and attached to said module. The possibility of attaching the ventilator module to the air treatment unit has the advantage of a permanently effective flow and treatment of the air in the air treatment unit, in particular by conveying an individually suitable air flow through the air treatment unit. On the other hand, a particularly simple, uncomplicated and fast interchangeability of the fan, and furthermore a particularly space-saving and convenient design for the operation and transport of the system components, is made possible. Furthermore, the ventilator module offers a selection option for the operation of the same in combination with a respective air treatment unit or as a separate ventilator device for the circulation of air in the room, i.e., without a connection to an air treatment unit and/or air treatment system.

The ventilator module particularly preferably comprises a coupling device by means of which, if necessary, the air treatment unit and/or a further module can be releasably coupled to a counter-coupling device corresponding to the coupling device. The further module can be designed, for example, as a ventilator module, an air treatment unit, an auxiliary module, a wall mounting device, a display module, a communication module, a GPS module, a light module, an accumulator module, a filter module, a control and/or regulation module or as an evaluation module. The counter-coupling device is preferably arranged on the lower face of the respective module or the respective system component. To attach the ventilator module to the air treatment unit, for example, the ventilator module can comprise a coupling device on its upper face, and the air treatment unit can comprise a counter-coupling device on its lower face, which is designed to correspond to the coupling device of the ventilator module and can accordingly be releasably coupled to the same. As a result, the ventilator module can be releasably fastened to the air treatment unit in a particularly secure, quick and uncomplicated manner, which makes it possible to save working time, for example, during the transport, storage or assembly of the system. Thanks to this modular design, new technologies, in particular, can be integrated into existing systems or retrofitted in such systems in a particularly quick and inexpensive manner.

Particularly preferably, the air treatment unit additionally comprises a coupling device on a housing side facing away from the counter-coupling device, in particular an upper face, which, in terms of construction and function, substantially corresponds to the coupling device of the ventilator module. As a result, a plurality of air treatment units and/or ventilator modules can be stacked on top of one another and fastened to one another, which is particularly advantageous for the transport of the units and/or modules. In particular, it can be provided that the ventilator module and/or the air treatment unit each comprise a coupling device on the upper face and a counter-coupling device configured to correspond to the coupling device on the lower face so that a plurality of ventilator modules and/or air treatment units can be stacked on top of one another and fastened to an adjacent component. As a result, particularly with regard to the ventilator modules, a relatively simple and safe transport of the modules is made possible; in particular, a plurality of ventilator modules can be carried in a simple and safe manner at the same time.

The coupling can take place mechanically and/or electrically. In particular, a coupling device with a correspondingly designed counter-coupling device can be provided for mechanical and/or electrical coupling. The mechanical coupling is to be understood in the present case as the fixing of the ventilator module to the air treatment unit while the electrical coupling is to be understood in the present case as the electrical connection of the two components by means of an interface.

For a mechanical coupling, for example, of the ventilator module with the air treatment unit, the coupling device arranged on the ventilator module can, for example, comprise at least one first coupling element, and the counter-coupling device arranged on the air treatment unit, for example, can comprise at least one first counter-coupling element with the first coupling element being able to engage with the first counter-coupling element in a preferably releasable manner so as to at least temporarily fix the first coupling element. The first coupling and counter-coupling elements are advantageously coordinated with one another with regard to their arrangement on the respective system component, i.e., they are designed to correspond to one another. The first coupling element and the first counter-coupling element can each comprise, in particular, a mechanical coupling. The first coupling element is designed, for example, as a retractable pawl, and the first counter-coupling element is designed as a recess into which the pawl can lock or engage. This provides for a particularly safe and uncomplicated, releasable mechanical coupling.

For an electrical coupling, for example, of the ventilator module with the air treatment unit, the coupling device arranged on the ventilator module can, for example, comprise at least one second coupling element, and the counter-coupling device arranged, for example, on the air treatment unit can comprise at least one second counter-coupling element with the second coupling element being able to come in contact with the second counter-coupling element in a preferably releasable manner so as to establish an electrical connection. The second coupling and counter-coupling elements are advantageously coordinated with one another with regard to their arrangement on the respective system component, i.e., they are designed to correspond to one another. The second coupling element and the second counter-coupling element can each comprise, in particular, an electrical coupling, such as a plug connection. This provides for a particularly safe and uncomplicated, releasable electrical coupling.

The ventilator module and/or the air treatment unit preferably comprises a particulate filter, in particular a HEPA filter. This allows the air to be treated in the respective system component to be cleaned and purified. Furthermore, the service life of the ventilator module, in particular, can be increased as a result. In one possible embodiment, the filter can be part of a separate filter module, which can comprise a coupling and a counter-coupling device so as to be coupled to another system component, as a result of which this module can be used individually. The air treatment unit can, for example, also be designed as a filter module. The filter can thus form a module of the system that can be exchanged particularly quickly and conveniently.

In a preferred embodiment, the ventilator module comprises at least one lateral outlet opening, which is preferably fluidically connected to the flow channel housing, on at least one housing wall extending between the upper face and the lower face in a region facing the lower face, in particular in the region of the housing base, in particular for laterally blowing the air flow in a plurality of directions in the room, substantially essentially all around, preferably in a spatial plane that is parallel to a contact or stand surface. With a ventilator module standing on the floor, for example, this lateral outlet opening or these lateral outlet openings have the effect that the air flowing from the ventilator module is initially distributed across the floor and thereby evenly throughout the room. Furthermore, a rotating air circulation can be generated with a corresponding alignment of the outlet flow in the room, which is advantageous, for example, for evenly absorbing moisture on building walls, and optionally for sucking said moisture into an air treatment unit and/or ventilator module. The at least one outlet opening can, in particular, extend from the surface forming the housing base in the direction of the upper face. A 360° outflow can be provided in this regard or an outflow limited to one or more angular ranges. This can also be implemented, for example, by means of a cross-flow fan. In addition, a connection for an air conveyance hose can be provided on the ventilator module. In particular, a connection for an air supply hose can be provided in the region of an air inlet of the ventilator module, and a connection for an air outlet hose can be provided in the region of the air outlet.

Particularly preferably, a plurality of guide bodies is arranged in a series between or within the at least one outlet opening and the impeller. As a result, the air conveyed through the ventilator module can additionally be guided in one direction and/or accelerated again in a last step when the air leaves the ventilator module so that the air conveyed from the ventilator can be distributed evenly and homogeneously in a room. The guide bodies, also called guide walls or guide surfaces, can be circularly arranged around the impeller and/or behind the impeller in the direction of flow and thus form an entire guide wheel or a guide wheel rim. The guide bodies are preferably aligned in their longitudinal extension perpendicular to the housing base surface. The guide bodies particularly preferably extend in the longitudinal direction from the upper face to the lower face of the ventilator module. The guide walls can be manually or automatically rotatably mounted about an axis aligned in the direction of their longitudinal extension, as a result of which, in particular, the flow angle of the guide surfaces can be changed and thus the air mass throughput, the flow velocity and/or the flow direction can advantageously be set or adjusted. The guide bodies are preferably connected to one another in such a way that when one of the guide surfaces is adjusted, all the other guide surfaces are adjusted as well.

The ventilator module preferably comprises in the housing base, in particular in a housing surface forming the housing base, a base outlet opening for blowing out the air flow substantially perpendicular to the stand surface. The base outlet opening can, in particular, be designed as a recess in the plane of the housing base that forms the stand surface of the ventilator module, through which the air flow conveyed by the ventilator module can alternatively or additionally be directed from the ventilator module, in particular perpendicular to the extension of the housing base surface of the ventilator module. This can be advantageous, for example, for drying screed, in the process of which the air flow is usually guided into the newly laid screed flow through a duct or hose. In this case, the optionally provided lateral outlet openings can be closed, for example, by means of a separately designed, in particular, ring-shaped closure cap or by means of a suitable adjustment of the optionally arranged guide bodies themselves.

The ventilator module particularly preferably comprises on the housing base, in particular on an outer housing surface forming the housing base, a circumferential sealing ring or sealing bellows for sealing the base outlet opening from at least one lateral region surrounding the ventilator module. As a result, all the accelerated air flowing from the ventilator module can flow almost loss-free in the direction of the floor or the wall against which the ventilator module rests, which is particularly advantageous for the drying of screed or a wall.

The air treatment unit can be designed, for example, as a cooling module for drying the air, as a heating module for heating the air or as a separately designed additional ventilator module for increasing the performance of the air circulation.

The air treatment unit configured as a cooling module can comprise, for example, at least one condenser along which and/or through which air can flow as well as a cooling device suitable for cooling the condenser. The condenser can be designed, for example, as a metal plate, preferably with cooling lines through which a refrigerant can flow. The cooling device can be designed, for example, as a heat pump which is known per se. The air flow conveyed through the cooling module is advantageously guided on or along the condenser by appropriate means. This can have the effect that the air flowing along the condenser condenses on the cooled condenser in the known manner, i.e., that it releases moisture to the condenser. In other words, moisture can be withdrawn from the air flow so that the moisture in the air flowing from the air treatment unit or the ventilator module is significantly reduced compared to the air sucked into the air treatment unit. The air treatment unit configured as a heating module can comprise, for example, at least one heating element through which or along which air can flow as well as a heating device suitable for heating the heating element or the combustion chamber. The heating element can be designed, for example, as a heatable heating grid or heatable heating rod or as a combustion chamber through which air can flow. The heating device can be operated, for example, electrically, with gas or with oil. This can have the effect that the air flowing through or along the heating element is supplied with heat in a known manner, for example, by means of a burner, and that the air flow is thus heated. Furthermore, the heating device can be designed as a heat pump that is known per se. In particular, the heating module can be designed to interact thermodynamically with the cooling module, for example, by interconnecting the heat pump circuit that forms the heat pump. The air treatment unit designed, for example, as an additional ventilator module, can correspond to the ventilator module in terms of design and function. Accordingly, in particular, a plurality of ventilator modules can be stacked on top of one another and coupled to one another. This is particularly advantageous for transport purposes. Furthermore, the speed of the air flow and thus the air mass throughput can, for example, be increased in a particular operation, as a result of which the air circulation in particularly large building interiors can be improved.

The air treatment unit designed as a heating module preferably comprises an oil-fired mini burner. As a result, the air can be heated in a particularly advantageous manner, in particular without the entry of moisture into the air, i.e., without increasing the humidity of the heated air, which is advantageous when drying building walls or floors. Furthermore, particularly on construction sites, the operation of the heating module and the provision of the fuel required for the heating are made possible in a particularly safe and uncomplicated manner, for example, by means of a separate heating oil tank.

The air treatment unit particularly preferably comprises, in particular on an outside of its housing, a connection for a heating oil supply hose that can be arranged from the outside and/or for an exhaust hose that can be arranged from the outside. As a result, when the system is operated, the air treatment unit can be arranged in a building interior while an oil tank connected to the air treatment unit via the heating oil supply hose is arranged outside the building, for example. The air treatment unit can be supplied with fuel by means of heating oil that is stored in the oil tank and that can be supplied to the air treatment unit via the heating oil supply hose. The oil tank or the heating oil to be stored can thus be stored in a secured location of the construction site, in particular in the region of an access road. Furthermore, the oil tank can advantageously be reached by a heating oil supplier, in particular a tanker, and the oil tank can be filled with heating oil in a particularly uncomplicated manner. The air treatment unit can have a connection for an exhaust hose in order to discharge the exhaust gases produced during the combustion of the heating oil. The exhaust hose can, in particular, extend from the air treatment unit located in a building interior to the outside of the building so that the exhaust gases can be diverted to the outside in a particularly uncomplicated manner and so that the building interior and the entire building can remain free of exhaust gases from the air treatment unit.

The air treatment unit designed as a cooling module preferably comprises, in particular on an outside of its housing, a connection for a water hose that can be arranged from the outside. The water hose is used, in particular, to divert water collected in or by means of the cooling module due to the condensation effect. For this purpose, the air treatment unit particularly preferably comprises a device for discharging water, in particular a pump. The water can thus be diverted to the outside of the building, for example, through the water hose. A cyclical and time-consuming emptying of a water collecting container of the air treatment unit is therefore not necessary.

The air treatment unit can advantageously comprise a flow channel housing with a flow axis or center line which, in a state coupled to the ventilator module, is oriented in its overall course substantially perpendicular to the stand surface of the ventilator module. As a result, the air treatment unit can be operated particularly effectively and constructed in a space-saving manner. Particularly preferably, the flow axis of the flow channel housing of the air treatment unit lies substantially in the flow axis of the flow channel of the ventilator module. A particularly efficient flow through the air treatment unit and the ventilator module can thereby be achieved. In particular, the air can be sucked in at an upper face of the additional unit, passed through the air treatment unit, guided into the ventilator module on a lower face of the air treatment unit, which rests against the upper face of the ventilator module, and then conveyed through the ventilator module and ultimately back to the lower face of the ventilator module toward the outside into the room. It is known that comparatively warm air containing a comparatively large amount of moisture rises to the top while comparatively cold air containing comparatively little moisture remains in the floor region. It is therefore preferably provided that the ambient air is sucked in at the upper face of a system component, for example, consisting of an air treatment unit designed as a cooling module and a ventilator module coupled to it, so that, in particular, relatively humid ambient air can be sucked into the system component. The suction can take place, in particular, by means of a negative pressure generated by the ventilator module on the upper face of the system component, the ventilator module preferably being arranged below the air treatment unit, and the negative pressure extending up to an upper face of the air treatment unit. The suctioned air can then be dried in the air treatment unit, in particular by removing moisture, transferred into the ventilator module in a lower region of the air treatment unit and accelerated in the ventilator module in the direction of an outlet opening of the ventilator module. The air blown from the ventilator module at the side, for example, with a relatively low level of humidity can then first flow along the building floor and absorb moisture from the floor, for example, to dry a screed, then rise again as comparatively warm and therefore comparatively high moisture-containing air and be sucked in again in the upper region of the system component. This closes the air flow circuit again. Optionally, the air on the lower face of the ventilator module of the air treatment unit designed as a cooling module can additionally be accelerated by a further separately designed ventilator module in order to be able to generate a homogeneous air distribution in a building room, and/or an air treatment unit designed as a heating module can supply heat so that still more moisture can be absorbed from the air along the floor and/or the walls. The direction of the flow through the air treatment unit and/or the ventilator module consequently serves to improve the drying effect, in particular in the case of a floor that is to be dried.

To supply the system components with resources or to dispose of resources, the ventilator module and/or the air treatment unit can be electrically and/or fluidically connected to a separately arranged auxiliary module at least in one operating state, in particular for an autonomous operation. The auxiliary module can, for example, be a liquid or gas distribution device, a liquid or gas storage device, or a battery or accumulator. The operating resource for the supply can be, for example, electricity, gas, in particular natural gas, or heating oil. The operating resource for the disposal can, in particular, be water collected from an air dehumidifier. An optional additional electrical connection between the auxiliary module and the ventilator module and/or the air treatment unit can be used for a data exchange, for example, for the transmission of data, which contains information about the auxiliary module, such as a liquid fill level, or the operating state of the ventilator module or the air treatment unit. As a result, a central auxiliary module can be provided, for example, which is operatively connected to a plurality of air treatment units and/or ventilator modules, in particular for supplying operating resources or for disposing of operating resources, particularly preferably depending on the data or data signals transmitted between these components. To monitor the data or data signals, a control and regulation module, which is electrically connected to the ventilator module and/or air treatment unit, can optionally be provided for controlling and regulating the system.

The auxiliary module particularly preferably comprises a gas or liquid tank, in particular a heating oil or water tank. A separately arranged water tank or water reservoir can be provided, which, for example, for an autonomous operation, is at least fluidically connected to at least one air treatment unit designed as a cooling module in order to convey the water collected in the air treatment unit from said unit to the water tank and temporarily store said water in said tank. The water tank can, for example, have a maximum capacity of about 10 liters. Such a water tank can, for example, be arranged on the floors of a building and receive and temporarily store the water from a plurality of air treatment units, in particular from a plurality of rooms in the building. Furthermore, a heating oil tank of an auxiliary module can be connected to an air treatment unit, in particular an air treatment unit designed as a heating module, in order to provide heating oil for the operation of the air treatment unit. Such a heating oil tank is preferably arranged outside the building, preferably on an access road to a construction site, so that it can be filled in the most uncomplicated manner possible. The capacity of such a heating oil tank is preferably between 1,000 and 10,000 liters.

The auxiliary module is particularly preferably designed as a water tank comprising a water extraction point, for example a water faucet. In this way, for example, on a construction site, water, for example, for mixing mortar or concrete, can be taken directly and in a particularly simple manner from the water tank. Furthermore, a regular or interval-like emptying of a water tank, for example, a condensation module, is not necessary, in particular for an autonomous operation of the system.

In a preferred embodiment, at least one control and/or regulation module is provided for the, in particular autonomous, control and/or regulation of the ventilator module, the air treatment unit and/or the auxiliary module. This allows for a comprehensive control and/or regulation of the entire system, as a result of which the efficiency and the operating costs of the system can be improved. In particular, regular manual readjustment or a regulation of the system components is not necessary. The control and/or regulation module can be designed as a separate unit which, preferably in the same way as the air treatment unit on the ventilator module, can be attached to the air treatment facility and/or to the ventilator module. For this purpose, the control and/or regulation module can comprise a counter-coupling device at least on a lower face so that the control and/or regulation module can be placed on the upper face, for example, of the ventilator module, and attached thereon. Particularly preferably, the control and/or regulation module can optionally be placed on all system components and connected to the respective component. As a result, for example, only one control and/or regulation module is required per system. Optionally, a coupling device can additionally be arranged on an upper face of the control and/or regulation module to which a system component with a corresponding counter-coupling device can be coupled.

The control and/or regulation module can be used, for example, to control and/or regulate the drive motor of the ventilator module or a supply pump for pumping heating oil or water. Furthermore, it can be provided that the control and/or regulation module can be used to control and/or regulate the air treatment unit, in particular the cooling output in the case of a cooling module, the heating output in the case of a heating module and the motor output of the impeller in the case of an additional ventilator module. The respective control and/or regulation can preferably take place, in particular autonomously, on the basis of predefined, manually entered, automatically recorded or calculated environmental parameters. It should be clear that, in the present document, the term “autonomous operation” is to be understood, in particular, as a separate and independent operation, in particular without any regular manual manipulation, control and regulation and/or the supply and disposal of operating resources. Such an autonomous operation can be provided for several hours, days, weeks or months, for example. The system can be controlled and/or regulated remotely, in particular by means of software that can be operated at a location other than the location where the system is installed, such as in a monitoring center, at a manufacturer or lessor, and a corresponding data transmission between the software and the system. The control and/or regulation module is particularly preferably suitable for controlling and/or regulating a plurality of system components, in particular one or more air treatment units connected to the ventilator module and/or one or more auxiliary modules connected to the air treatment unit. With such a centrally arranged or interconnected control and/or regulation module, the system can be manufactured and operated in a particularly cost-effective manner. In particular, the autonomous operation and the performance control via software that generates the parameters required for this purpose, for example, by means of a sensor module, also leads to particularly high energy savings. The control and/or regulation module can be designed separately or can be integrated into the ventilator module, the air treatment unit or the auxiliary module. When designed as an integrated module, the control and/or regulation module is preferably encased by the corresponding housing of the ventilator module, the air treatment unit or the auxiliary module.

The control and/or regulation module preferably comprises at least one detection sensor for detecting the ambient temperature, the ambient humidity, an ambient movement, the intrinsic movement, the ambient brightness, a connection to an external voltage supply, a battery power, a tank fill level, a removal of a water container, a tensile stress on a support device, a distance to at least one building wall and/or building ceiling, a type of installation and/or an operating mode. As a result, a control and/or regulation of the system components that is individually adapted to the respective environmental properties and/or current situation can take place on the basis of the recorded parameters. This is particularly advantageous for the autonomous operation of the system. The heat output of the heating module can, for example, be regulated on the basis of the ambient temperature, which changes over time, and the cooling output of the cooling module can be regulated on the basis of the ambient air humidity, which changes over time. The term environment is to be understood, in particular, as the interior of the building in which the control and/or regulation module is located. The detection of movements, for example, by means of a movement detector or sensor known per se, is used, for example, to control a display or lighting device or also to send out an alert if the system component is suspected of being stolen. When a person entering the room is detected, for example, the display device, lighting device, a data interface for data transmission and/or another component can be activated. The ambient brightness can be used, for example, to control the lighting device. The detection of a power supply or battery power can serve to monitor the current operating state and/or to calculate the battery power or operating time of the system component that is still available. A warning signal can be emitted, for example, when a power supply line is disconnected or when the battery level is low. The detection of a fill level in a tank and the removal of the water container, in particular from an air treatment unit, is used, in particular, to monitor and ensure a safe operation of the system. A warning signal can be emitted, for example, when a certain liquid fill level is exceeded or when the water container is removed, for example, from a cooling module. The warning signal can be, for example, acoustic, visual or a data signal for the transmission to a receiving point, such as a central control center. The detection of a tensile stress of the support device can, for example, also be used to indicate a suspected theft, which can also trigger the warning signal described above. The detection of the distance to a building wall and/or ceiling, as well as the installation and operating mode, in particular as a floor-standing device, wall-mounted device or ceiling device, can be used to calculate the parameters required for the treatment of the air, in particular the room size. As a result, the system can be individually controlled and regulated for every room size and can therefore be operated particularly effectively and inexpensively. The operating mode can also include information about the operation of the respective system component as a ventilator module, air treatment unit operated as a cooling module or heating module, auxiliary module or control and/or regulation module and serve the respective type of control.

The control and/or regulation module particularly preferably comprises an evaluation module for evaluating the data acquired by means of the at least one acquisition sensor, in particular for storing, determining or calculating and/or outputting data values, in particular for activating and/or regulating the ventilator module, the air handling unit and/or the auxiliary module. By means of the evaluation module, the system components can be controlled and/or regulated in a preferable manner that is individually tailored to the respective operating situation, in particular on the basis of the data detected by means of the detection device. The dimension or size of the room, for example, and the parameters required for treating the corresponding air can be calculated for controlling the system components by means of the evaluation module on the basis of the recorded distance data between the control and/or regulation module and a building wall or ceiling. As already mentioned above, the evaluation module can comprise a coupling and counter-coupling device so that it can be coupled to at least one other system component, for example, the ventilator module. This makes it possible to use this module individually.

In an operating state, the ventilator module, the air treatment unit, the auxiliary module and/or the control and/or regulation module can be connected to one another electrically and/or fluidically. As a result, the system components can also be functionally connected to one another. An air treatment unit in the form of a cooling module can, for example, be at least fluidically connected via a water hose to an auxiliary module in the form of a water tank; an air treatment unit in the form of a heating module can be at least fluidically connected via a heating oil supply hose to an auxiliary module in the form of a heating oil tank; and a ventilator module can be at least electrically connected to all air treatment units. In this case, all system components can be connected electrically in series, for example, for the power supply. This way, complex cabling can be avoided.

The ventilator module, the air treatment unit, the auxiliary module and/or the control and/or regulation module preferably comprises a display device or a display module, in particular a display that is also suitable as an input field. The display device can be designed as a so-called touch panel, which is used in a known manner both for displaying information and for operating and navigating the menu, in particular by tapping or touching said panel with one or more fingers. As a result, information can be taken from the ventilator module, air treatment unit and/or the auxiliary device and entered directly and in an uncomplicated manner. Such information can relate, for example, to the current operating mode, an efficiency, a liquid fill level, a charge level of a rechargeable battery or the like. The display device can be designed as a module which, as already mentioned above, can comprise a coupling and a counter-coupling device so that it can be coupled to at least one other system component, for example, the ventilator module. This makes it possible to use this module individually.

The ventilator module, the air treatment unit, the auxiliary module and/or the control and/or regulation module preferably comprises a communication module for sending and receiving data via the Internet. This makes it possible, in particular, to read out data and/or to control system components remotely, for example, from a central monitoring and/or control point. The communication module can comprise a coupling and a counter-coupling device so that it can be coupled to at least one other system component. This makes it possible to use this module individually.

The communication module, the ventilator module, the air treatment unit, the auxiliary module and/or the control and/or regulation module particularly preferably comprises a data communication interface, in particular a wireless data communication interface. As a result, all components of the system can be integrated into a network in a particularly simple manner. The data communication interface can be a USB interface, for example. The wireless data communication interface can be, for example, a radio interface, such as a Bluetooth or WLAN antenna. The interface can, in particular, be suitable for transferring data to or from a cell phone, tablet, laptop, computer or via the Internet. This is particularly advantageous, for example, when monitoring or maintaining the system components.

Furthermore, the ventilator module, the air treatment unit, the auxiliary module and/or the control and/or regulation module can comprise a GPS module. This makes it possible to determine at any point in time where the corresponding system component is located in a relatively precise manner. This is particularly advantageous for monitoring the system components. The GPS module advantageously comprises its own accumulator for a self-sufficient power supply, for example, in the event of theft. The GPS module can furthermore be formed separately and, in particular, comprise a coupling and counter-coupling device so that it can be coupled to at least one other system component, for example, the ventilator module. This makes it possible to use this module individually.

On construction sites, the interior of the building must be illuminated, in particular for processing purposes and as an occupational health and safety measure, especially when there is little daylight, such as in the winter months in the morning and in the late afternoon. In particular in rooms in which walls or ceilings are being worked on, in particular plastered or painted, it is essential for the work that these rooms are sufficiently illuminated. Furthermore, it is mostly precisely in these rooms and for this type of work where a quick drying of the processed surfaces and thus a removal of moisture from the ambient air is desirable. The ventilator module and/or the air treatment unit can therefore comprise a lighting means for illuminating a room, in particular for illuminating the room. As a result, additional lighting, including mostly cumbersome cabling, is not required in a building interior, in particular on construction sites. The lighting means can be part of a module which can be designed separately and which can comprise a coupling and a counter-coupling device for coupling to another system component so that this module can be used individually.

In addition, a plurality of devices and/or machines are operated at the same time on most construction sites. Since there is usually no building-side infrastructure at most construction sites, in particular no electrical power supply, cables and junction boxes have to be laid in the respective building interior. Due to the cables lying around, there is often a risk of people stumbling or slipping. In one embodiment, it is therefore provided that the ventilator module and/or the air treatment unit comprises an electrical distribution device with at least one electrical plug connection to which a device plug can be coupled. As a result, an electrical power supply can be centrally provided in a respective building interior. The electrical distribution device can, for example, comprise various commonly used plug connections. The electrical distribution device can, for example, comprise one or more connections protected by a 16- or 32-ampere fuse so that a suitable protection is made possible for each individual application. Furthermore, the electrical distribution device can be designed as a separate component which, for example, is connected to the ventilator module, for example, via just one cable. As a result, the distribution device can, for example, be moved and/or displaced to a different location within the room than the ventilator module and/or the air treatment unit. This can be advantageous, for example, in the case of an extension cable that is required for work purposes but not available on site. The electrical distribution device can be part of a module which can be designed separately and which can comprise a coupling and a counter-coupling device for coupling to another system component so that this module can be used individually.

As already mentioned above, the ventilator module can operate not only as a floor-standing device but also as a wall or ceiling device. For this purpose, the ventilator module can comprise a wall mounting device in a region facing the lower face for fastening at least the ventilator module to a building wall or ceiling. In the simplest case, such a wall mounting device can be designed as a web with a bore through which a fastening screw that can be connected to the wall or ceiling can extend.

Furthermore, the ventilator module, the air treatment unit, the auxiliary module and/or the control and/or regulation module can comprise a supporting/lifting device, in particular comprising at least two straps, so that just one person can carry the system component. As a result, the transport of the system components can be made significantly easier, in particular in higher floors of a construction site, which can usually only be reached via stairs. The respective system components can be carried by a person on their back, in particular in the manner of a backpack, with the carrying straps being able to form the backpack straps. Furthermore, the carrying straps can be used to mount the respective component on the wall. The straps can, for example, be attached to the system that is used for a wall mounting. The carrying straps are particularly preferably fastened to an insertion device which can be releasably connected, in particular fastened, to the ventilator module, the air treatment unit, the auxiliary module and/or the control and/or regulation module. In particular, the insertion device can be designed, for example, as a metallic plate to which the carrying straps are attached and, as such, can be pushed into a receiving device arranged on the respective system component and at least temporarily fixed thereon. As a result, the slide-in device with the carrying straps can be used in a modular manner, in particular alternating with the respective system components to be transported. Particularly preferably, a device for rolling up the carrying straps can also be provided on the slide-in device so that the carrying straps can be stowed away in a particularly space-saving manner.

In an advantageous embodiment, the ventilator module, the air treatment unit, the auxiliary module and/or the control and/or regulation module comprise an accumulator for supplying power. As a result, the system components can be operated self-sufficiently or independently and can be operated in a respective building interior in a particularly simple and uncomplicated manner. In particular, complex cabling can be avoided. The accumulator can be part of a separate accumulator module, which can comprise a coupling and a counter-coupling device for coupling with another system component, so that this module can be used individually.

Particularly preferably, at least the ventilator module, the air treatment unit, the communication module, the GPS module, the accumulator module and/or the control and/or regulation module each have a water-impermeable housing, in particular with a degree of protection of at least IP68. Of course, higher degrees of protection are also possible. Furthermore, the heating module, the display module, the filter module, the evaluation module and/or any other module of the system can also have such a water-impermeable housing. The housing consequently surrounds and protects, in particular, the mechanics and/or electronics of the module. It can also form the support structure of the module. When the module is cleaned, water can enter, of course, and/or pass through the air duct of the module through which air can flow during operation. This serves, in particular, to ensure that the respective module can be cleaned in a particularly simple and convenient manner, for example, by means of a cleaning device such as a high-pressure cleaner or a water bath.

According to the invention, a ventilator device for accelerating air in building interiors, having the features of the ventilator module according to any of claims 1 to 34, is provided.

Four exemplary embodiments of the invention are explained in more detail below with reference to the figures. Like reference signs denote like components. Schematically, in the drawings:

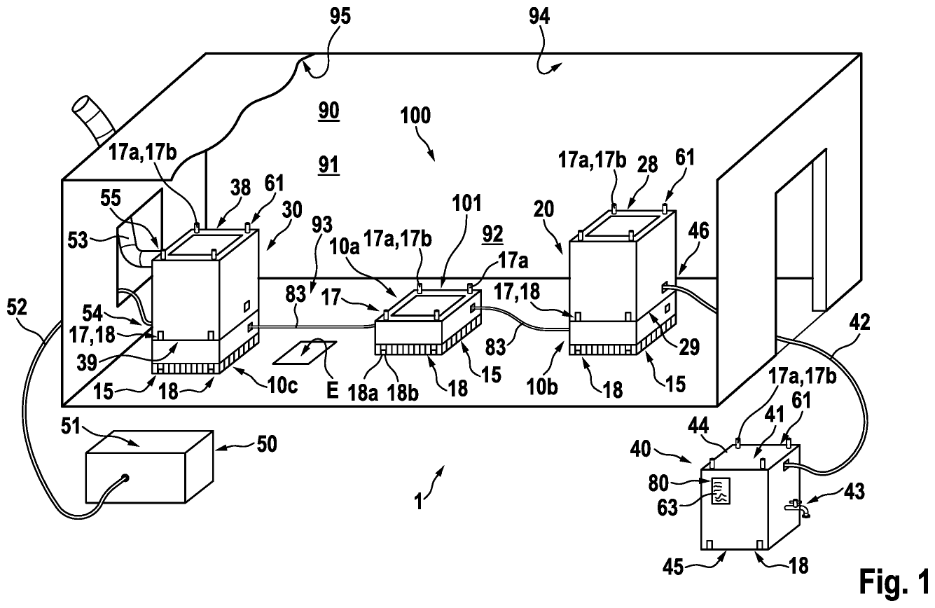

FIG. 1—is a system according to the invention in an operating state for use on the floor of a building in a perspective partial sectional view;

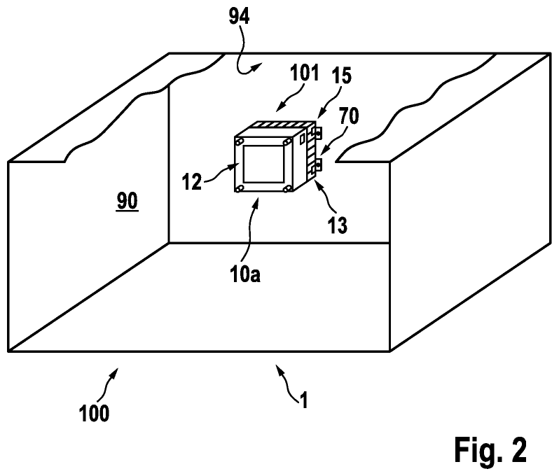

FIG. 2—is a ventilator device of the system according to the invention in an operating state for a wall application;

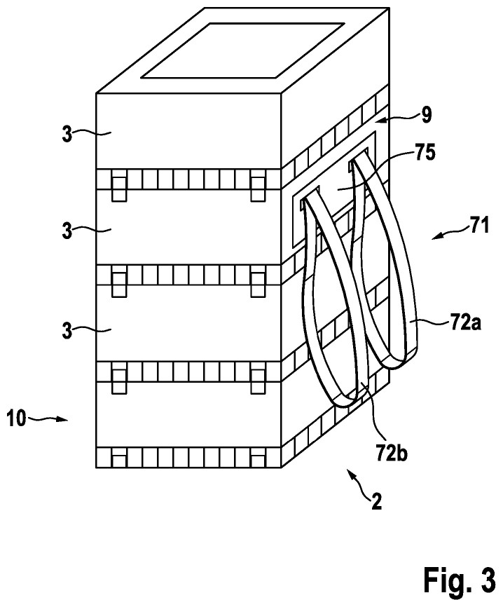

FIG. 3—is a representation of a plurality of ventilator devices of the system according to the invention in a transport state;

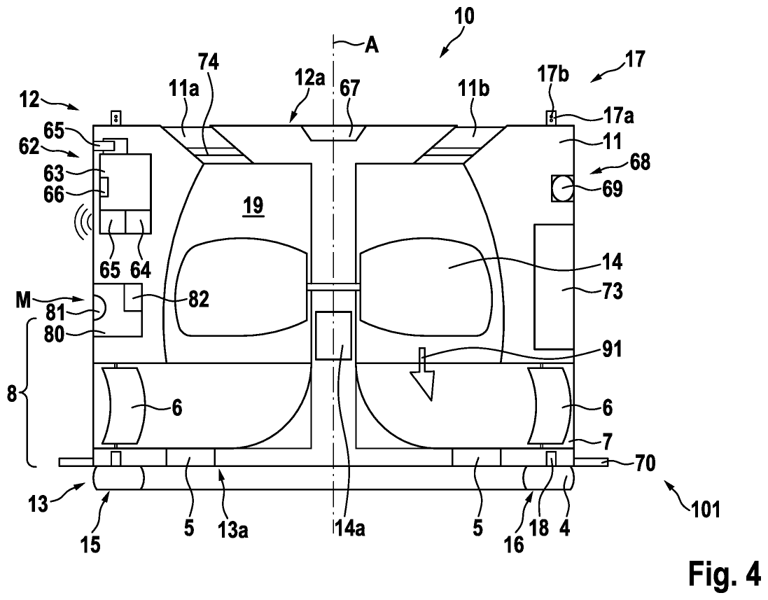

FIG. 4—is the ventilator device in a sectional view;

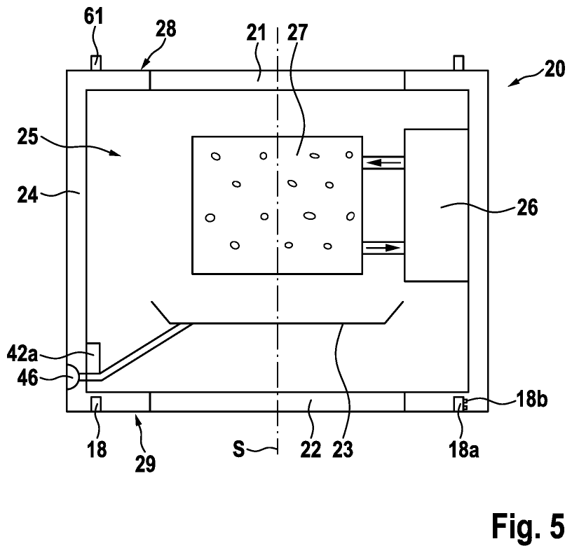

FIG. 5—is an air treatment unit designed as a cooling module of the system according to the invention in a sectional view;

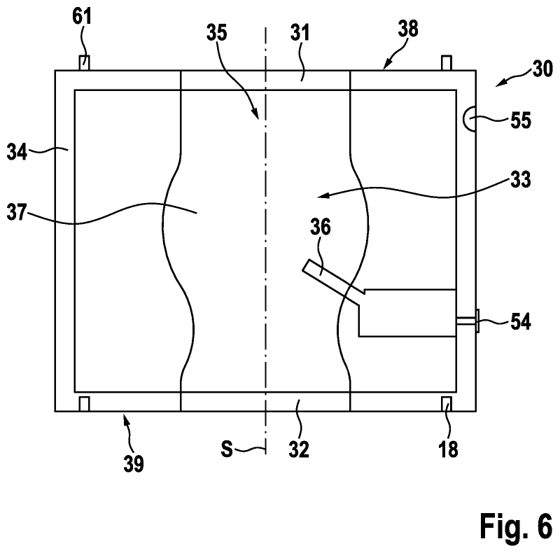

FIG. 6—is an air treatment unit of the system according to the invention designed as a heating module in a sectional view and

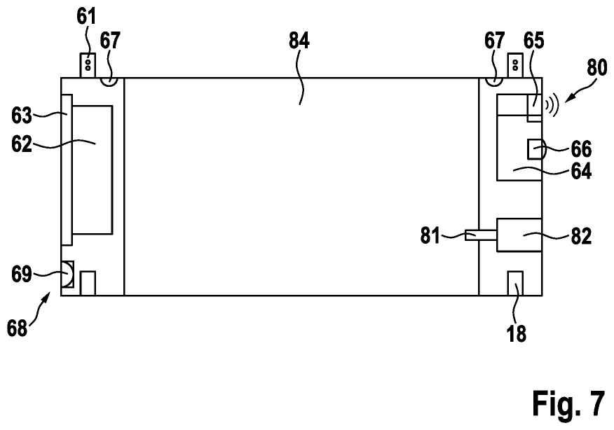

FIG. 7—is a control and/or regulation module of the system according to the invention in a sectional view.

FIG. 1 shows a system 100 according to the invention for treating air 91 in a building interior 90 of a building (not shown in greater detail) in an operating state 1. The system 100 can be used, for example, in newly constructed, renovated or dilapidated buildings or parts of buildings and serves, in particular, to create an ambient climate suitable for drying building parts, such as a building floor 93, a building wall 94 or a building ceiling 95. In particular, in the case of new buildings extending over a plurality of floors, for example, a high-rise building, the system 100, which is particularly suitable for an autonomous operation, can be used particularly advantageously.

In the application shown in FIG. 1, in particular a floor application in which the system components are operated as floor-standing devices on a floor, the system 100 is provided, for example, for drying a floor 93 of the room 90, in particular the screed. In the present case, the system 100 comprises, in particular, a separately operated first ventilator module 10a, a second ventilator module 10b coupled to a first air treatment unit 20, a third ventilator module 10c coupled to a second air treatment unit 30, a first auxiliary module 40 and a second auxiliary module 50.

In the present case, the ventilator modules 10, 10a, 10b, 10c, which are each also referred to as the ventilator device 101, are always constructed and designed in the same way, in particular as shown in detail in FIG. 4. Due to their structural design, in particular with an optimized soundproof housing, all modules, in particular the ventilator module 10, 10a, 10b, 10c and the air treatment unit 20, 30, are particularly quiet when in operation.

The separately operated first ventilator module 10a is used in the present case exclusively to generate a uniform and homogeneous air circulation in the entire room 90. The use of a separately operated ventilator module 10 is therefore advantageous, particularly in the case of particularly large rooms 90. The ventilator module 10a can, in this case, be viewed as a device in the system 100 which supports the drying effect, for example, the drying of a newly produced building floor 93, in particular a screed floor.

The second ventilator module 10b coupled to the first air treatment unit 20 is used in the present case, in particular to convey an air flow through the air treatment unit 20. The air treatment unit 20 as such is shown in more detail in FIG. 5. The air treatment unit 20 comprises a housing 24 which forms a flow channel having a flow center line S. The air treatment unit 20 is designed, in particular, as a cooling module 25, which comprises a condenser 27 along which the air flow generated by the second ventilator module 10b can flow, in particular a cooled condenser, as well as a cooling device 26 that serves to cool the condenser 27. As a result, moisture can be removed from the air 91 when it flows along the cooled condenser 27, in particular due to a corresponding condensation of the moisture on the condenser 27. The cooling device 26 can, in particular, be designed as a heat pump known per se. The air flow is guided through the air treatment unit 20, in particular from an upper face 28 to a lower face 29. For this purpose, at least one air inlet opening 21 is advantageously provided on the upper face 28, and at least one air outlet opening 22 is provided on the lower face 29, which is shown, in particular, in FIG. 5. The air flow is particularly preferably conveyed through the air treatment unit 20 in a rectilinear manner, i.e., without loops. On the lower face 29, the air flow is conveyed from the air treatment unit 20 into the ventilator module 10b through at least the one outlet opening 22, which is correspondingly arranged with the inlet opening 11a, 11b of the ventilator module 10b. The air dried in the air treatment unit 20 can then be released again into the room 90 through corresponding outlet openings 7 by means of the second ventilator module 10b. The water absorbed or deposited in the air treatment unit 20 during the dehumidification and collected by means of a trough 23 is not permanently collected in the air treatment unit 20 but instead is conveyed to the auxiliary module 40 via a water hose 42. For this purpose, for example, a water hose 42 can be connected to a connection 42a on the air treatment unit 20. Furthermore, a pump 42a for conveying the water through the water hose 42 can be provided on the air treatment unit 20.

The auxiliary module 40 comprises, in the present case, a liquid tank 41, in particular a water tank, in which the water supplied by one or more air treatment units 20 and via one or more water hoses 42 can be collected. The auxiliary module 40 is therefore advantageously set up on a centrally located building corridor, in the case of multi-level buildings optimally in each case on one level of the building. For a better overview, FIG. 1 only shows a single water hose 42 connected to the auxiliary module 40, but, in principle, a plurality of water hoses 42 can be connected to the auxiliary module 40 at the same time. In principle, the water hose 42 can also have means for an electrical connection, for example, for the transmission of data signals, for example, through a cable duct running parallel to the water hose. The auxiliary module 40 comprises a water extraction point 43 on one side, via which the water temporarily stored in the water tank 41 can be removed as needed. The water extraction point 43 is designed, for example, as a water faucet from which the water stored in the water tank 41 can be tapped. The tapped water can be used, for example, on construction sites to mix mortar or concrete. As a result, the long supply hoses and/or long work paths usually provided for this purpose of making water available to a respective work location are no longer required. Furthermore, an autonomous operation is made possible over a particularly long period of time. The auxiliary module 40 also comprises a display and input device 63, which is described in more detail below.

The third ventilator module 10c coupled to the second air treatment unit 30 is used in the present case, in particular to convey an air flow through the second air treatment unit 30. The air treatment unit 30 as such is shown in more detail in FIG. 6. The air treatment unit 30 comprises a housing 34 with a flow channel having a flow center line S and is designed, in particular, as a heating module 35, comprising, in particular, a heatable heating element 37 through which and along which an air flow generated by the third ventilator module 10c flows, as well as a heating device 36 for heating the heating element 37, in particular a mini burner. As shown in FIG. 6, the heating element 37 can, for example, be designed as a combustion chamber 33. As a result, heat can be supplied to the air 91 when the air flows through or over the heated heating element 37. The air flow is guided through the air treatment unit 30, in particular from an upper face 38 to a lower face 39. For this purpose, at least one air inlet opening 31 is advantageously provided on the upper face 38, and at least one air outlet opening 32 is provided on the lower face 39. The air flows particularly preferably in a straight line, i.e., it passes through the air treatment unit 30 without any reversing or meandering of the air flow. On the lower face 39, the air flow is guided from the air treatment unit 30 through the at least one outlet opening 32 correspondingly arranged with an inlet opening 11a, 11b of the ventilator module 10c into the ventilator module 10c. The air heated in the air treatment unit 30 can then be released again into the room 90 through corresponding outlet openings 7 by means of the third ventilator module 10c.

In principle, the heating device 36 can be operated electrically, with gas or with oil. In the present case, the heating device 36 is operated by means of heating oil, which is supplied from the auxiliary module 50 to the heating device 36 via a heating oil hose 52 that can be connected to the air treatment unit 30, in particular to a connection 54. The supply of heat by means of an oil-operated burner is particularly advantageous in that the air to be heated is not supplied with moisture, as is the case with gas firing, so that the overall drying efficiency for the room 90 is not adversely affected. The exhaust gases produced during the combustion in the heating device 36 can be removed from the room 90 or from the entire building in a particularly simple manner via an exhaust hose 53 that can be connected to the air treatment unit 30, in particular to a connection 55.

The auxiliary module 50 comprising a heating oil tank 51 is advantageously arranged outside the building, preferably in a secured region of a construction site that is easily accessible by a tanker. If the construction site comprises a plurality of individual buildings, the auxiliary module 50 is preferably arranged centrally to these buildings so that the air treatment units 30 located in each building are particularly advantageously supplied with heating oil. For this purpose, a plurality of individual heating oil hoses 52 can, of course, be arranged on the auxiliary module 50, which is not shown here for clarity purposes. In principle, the heating oil hose 52 can also have means for an electrical connection, for example for the transmission of data signals, for example through a cable duct running parallel to the heating oil hose. The auxiliary module 50 can also comprise a display and an input device 63, which is not shown here.

As can be seen, in particular from FIG. 1, each of the system components 10, 20, 30, 40, 80 comprises, with the exception of the heating oil tank 50, a coupling device 17 or 61 and a counter-coupling device 18. The coupling device 61 is constructed in the same way as the coupling device 17; accordingly, what is stated below for the coupling device 17 likewise applies to the coupling device 61. Due to the design of the coupling device 17 and the counter-coupling device 18, in particular, the ventilator module 10 can be fastened to the respective air treatment unit 20, 30. With the exception of the heating oil tank 50, it is also possible to fasten all system components 10, 20, 30, 40 to one another, for example, for application purposes or for transport purposes. In particular, this allows for a quick and uncomplicated exchangeability of the component that is frequently subjected to the highest stress on a construction site, in particular the ventilator module 10. Furthermore, a plurality of individual system components 10, 20, 30, 40 can, for example, be transported at the same time in a safe and convenient manner.

In the present example, the coupling device 17 comprises a total of four first coupling elements 17a and at least two second coupling elements 17b. The coupling elements 17a, 17b are preferably each arranged in a corner region of an upper face 12, 28, 38, 44 of a respective system component 10, 20, 30, 40. The coupling device 17 in the ventilator module 10 is arranged on the upper face 12, in the air treatment unit 20 designed as a cooling module 25 on the upper face 28, in the air treatment unit 30 designed as a heating module 35 on the upper face 38 and on the auxiliary module 40 on the upper face 44. The first coupling elements 17a are used, in particular, for a mechanical coupling or fastening and the second coupling elements 17b for an electrical connection. It can be provided that the first coupling part 17a and the second coupling part 17b are realized by a common component, for example, a protruding pin or web made of an electrically conductive material.

The counter-coupling device 18 is correspondingly arranged on a lower face 13, 29, 39 of a respective system component 10, 20, 30, 40 and, in the present example, comprises a total of four first counter-coupling elements 18a and at least two second counter-coupling elements 18b. In the ventilation module 10, the counter-coupling device 18 is arranged on the lower face 13, in the air treatment unit 20 designed as a cooling module 25 on the lower face 29, in the air treatment unit 30 designed as a heating module 35 on the lower face 39 and on the auxiliary module 40 on the lower face 45.

In turn, the first counter-coupling elements 18a serve for a mechanical coupling or fastening and the second counter-coupling elements 18b for an electrical connection. It can be provided that the first coupling part 17a and the second coupling part 17b are realized by a common component, for example, a receptacle made from an electrically conductive material for the coupling device 17 designed as a protruding pin or web. To establish an electrical connection, it is provided, in particular, that, in a coupled state, at least the second coupling element 17b rests against the second counter-coupling element 18b or comes into contact with the same.

An essential feature of the invention is the electrical interconnection of the individual system components 10, 20, 30, 40, 50 with one another, in particular for control and/or regulation purposes. The ventilator module 10, the air treatment unit 20, 30 and/or the auxiliary module 40, 50 therefore comprises at least one control and/or regulation module 80. In FIG. 1, the control and/or regulation module 80 is arranged on the auxiliary module 40, for example, and in the example shown in FIG. 4, on the ventilator module 10. In FIG. 7, the control and/or regulation module 80 is shown as a separately designed unit that can be coupled to the other system components 10, 20, 30, 40.

The control and/or regulation module 80 is used, in particular, for the autonomous control and/or regulation of at least one of the system components 10, 20, 30, 40, 50. For this purpose, the control and/or regulation module 80 is electrically connected to each of the system components 10, 20, 30, 40, 50 for the transmission of data signals via electrical connecting lines 42, 52, 83. The connecting line 83 is designed as a conventional cable, and the connecting lines 42, 52 are designed as electrical lines arranged parallel to a respective fluid hose and attached thereto.

The control and/or regulation module 80 can, in particular, be part of a computer unit 62 and is used, in particular, to record environmental parameters 92 that are prevalent in the current environment. For this purpose, the control and/or regulation module 80 comprises at least one detection sensor 81 for detecting at least one environmental parameter 92. The at least one detection sensor 81 can, for example, be used to detect an ambient temperature, an ambient air humidity, an ambient movement, an intrinsic movement, an ambient brightness, a connection to an external voltage supply, a battery power, a tank fill level, a removal of a water container, a tensile stress on a support device 71, a distance to at least one building wall 94 and/or building ceiling 95, a type of installation and/or an operating mode.

The control and/or regulation module 80 comprises an evaluation module 82 for evaluating the recorded data. Just like the computer unit 62, the evaluation module 82 serves for storing, calculating and/or outputting data, in particular data signals. As a result, the parameters detected by means of detection device 81 can be evaluated by means of the evaluation module 82, and this resulting data can be used to control and/or regulate the individual system components 10, 20, 30, 40, 50. When used for drying a building wall 94 with a detected decreasing air humidity in the room 90, for example, the output of the drive motor 14a of the fan wheel 14 of the ventilator module 10b coupled to the air treatment unit 20 as well as the heating oil supply into the air treatment unit 30 can be decreased while the output of the drive motor 14a of the fan wheel 14 of the ventilator module 10a can be increased in order to allow for an optimal air circulation in the entire room 90, in particular along the building wall 94, in particular for removing moisture from the building wall 94 into the air 91.

The display and input device 63 provided by way of example on the auxiliary module 40 in FIG. 1 can, in principle, be arranged on any component 10, 20, 30, 40, 50 of the system 100. In FIG. 4, the arrangement of the display and input device 63 on the ventilator module 10 is shown as an example. The display and input device 63 is used, in particular, to display information about, for example, the respective system component 10, 20, 30, 40, 50 such as an operating state, in the present example in FIG. 1 regarding a fill level of the water tank 41, and/or regarding ambient conditions 92, such as the ambient temperature or the ambient humidity. Preferably, additional data, values or the like, for example, data for controlling and/or regulating a respective system component 10, 20, 30, 40, 50, can be input by means of the display and input device 63. For this purpose, the display and input device 63 can be designed, for example, in the form of a so-called touchpad display. Alternatively, the data can be displayed and/or entered via a mobile device, in particular a smart device such as a tablet, smartphone or the like.

In principle, the display and input device 63 can be part of a computer unit 62 comprising further electronic modules or components, as shown by way of example in FIG. 4. A communication module 64, a data communication interface 65 and/or a GPS module 66 can also be provided, for example.

The communication module 64 can, in particular, serve for the forwarding and/or processing of data signals, in particular bus or field bus data, for example, for the control and/or regulation of the individual system components 10, 20, 30, 40, 50. Furthermore, the communication module 64 can be designed to be particularly suitable for transmitting and receiving data via the Internet so that control and/or regulation of the system components 10, 20, 30, 40, 50 is also possible via the Internet.

The data communication interface 65 is used, in particular, for a connection to a network or a separate external device on site. The data communication interface 65 can, for example, be designed as a USB interface to which an external input/output device such as a mobile phone, tablet or laptop can be connected. This allows for a relatively convenient operation of the system 100, particularly when the system 100 is started up, serviced or repaired, in particular on a construction site. For a particularly convenient operation of the system 100, the data communication interface 65 can be designed as a so-called wireless data communication interface, which, for example, comprises a radio antenna for a Bluetooth or WLAN connection, for example. In particular, it is provided that all system components 10, 20, 30, 40, 50 can be operated, in particular controlled or read, from a single data communication interface 65 by means of a corresponding networking. The networking of the system components 10, 20, 30, 40, 50 can be established, for example, with a Bluetooth or WLAN network connection generated by the data communication interface 65 and/or the communication module 64.

The GPS module 66 is used, in particular, to locate a respective device, for example, when it is not used and stored in a warehouse, when used on a construction site or when the respective system components 10, 20, 30, 40, 50 having the GPS module 66 are stolen. The GPS module 66 can, in particular, comprise a rechargeable battery in order to be able to transmit/receive signals in the event of a theft.

To avoid having a large number of separate items in a room 90 of a building under construction, it is provided that a light 67 is arranged on the ventilator module 10, in particular on the upper face side 12, which is suitable for lighting a room 90. For this purpose, the light 67 can have, for example, at least one light source, such as an LED, which, in particular when the ventilator module 10 is arranged on a building ceiling 95, is suitable for lighting a room with a size of approximately 40 m². Such a light 67 can, of course, also be arranged on the other system components 20, 30, 40, 50. A circumferential light band can be arranged on the upper face of the heating oil tank 50, for example, in order to increase safety.

To avoid complex cabling and separate electrical distributors in a room 90, a respective system component 10, 20, 30, 40, 50 can comprise an electrical distribution device 68 with at least one electrical plug connection 69. The system components 10, 20, 30, 40 per se or also other devices, such as construction machines, tools, battery chargers or the like, can be connected to the plug connection 69 for a power supply. Power can be provided to the individual system components 10, 20, 30, 40, for example, by an external power supply or by an accumulator 73, as shown by way of example in FIG. 4 on the ventilator module 10.

In FIG. 2, the ventilator module 10a, which is also referred to as the ventilator device 101, is shown in an operating state 1 and is used as a wall unit. The ventilator module 10a is arranged on a building wall 94 of a room 90, in particular with the lower face 13 resting against the housing wall 94. The ventilator module 10a can be fasted the wall 94 by means of, for example, a wall mounting device 70—optionally also designed as a module—which can comprise fastening screws (not shown in more detail), or by means of a strap system 71.

The strap system 71, which is shown, in particular, in the transport state 2 shown in FIG. 3, is used, in particular, to fasten a system component 10, 20, 30, 40 to a building wall 94 or ceiling 95 and also to primarily facilitate the transport of the respective system component 10, 20, 30, 40. FIG. 3 shows a transport state, in particular, for transporting four identically designed ventilator modules 10 or ventilator devices 101, with three additional ventilator modules 3 designed in the same way as the first ventilator module 10 being stacked on the upper face of a first ventilator module 10. The strap system 71, also called a support device, is arranged on a housing wall 9 of one of the ventilator modules 3, 10. The support device 71 comprises two straps 72a, 72b, which are preferably adjustable in length, with each arranged on a holding plate 75. The holding plate 75 can be designed as a metal plate, for example, which can be fixed to the housing wall 9 of the ventilator modules 3, 10 via a fastening system, for example, a rail system, which is preferably arranged on the rear of the metal plate, and which can, in particular, be inserted and locked in a receptacle arranged on the side wall. As a result, according to the present example 4, ventilator modules 10, which are generally relatively lightweight, can be particularly comfortably carried or transported via the strap system 71 by a person in the manner of a backpack.

The ventilator module 10, 10a, 10b, 10c comprises—as shown, in particular, in FIG. 4—a housing 11 with an upper face 12 and an opposite lower face 13. Between the upper face 12 and the lower face 13, a flow channel 19 formed by the housing 11 extends in which, approximately in the middle M of a height between the upper face 12 and the lower face 13, an impeller 14, which can be rotated about a rotational axis A and set in rotation by a drive motor 14a, is arranged for conveying an air flow 91 through the flow channel 19. The rotational axis A is aligned substantially perpendicular to a stand surface 16 of the ventilator module 10, which is formed on the lower face 13 by a housing base 15.

In the present case, the upper face 12 and the lower face 13 are not only to be understood as the respective forming end or upper face 12a, 13a of the respective side 12, 13 but rather a region or portion between the respective end surface 12a, 13a and the middle M of the height of the ventilator module 10 extending across a height portion. In FIG. 4, for example, the lower face 13 extends across the region 8.

In the present case, at least one inlet opening 11a, 11b for taking or sucking in air 91 from the environment 90 into the flow channel 19, which in the present case is, in particular, ring-shaped, is arranged on the upper face 12. The flow channel 19 then extends from the inlet opening 11a, 11b in the direction of the lower face 13, and, in the present case, opens there, among other things, into lateral outlet openings 7, in particular, surrounding the housing 11. As a result, the air 91 taken in at the upper face 12 can be accelerated by means of the impeller 14 and blown out at the lower face 13 in the lateral direction away from the ventilator module 10 into the room 90 so that the blown air can initially flow along the building floor 93 and thus create an air circulation in the entire room 90. In the present case, a plurality of guide bodies 6, in particular arranged in series, are provided between the outlet openings 7 and the impeller 14.

The guide bodies 6 serve, in particular, to align the air flow blown out of the ventilator module and to close the outlet openings 7 as needed. The air flow 91 can, in particular, flow out of the ventilator module 10 in a plurality of directions in the room, all around, preferably substantially in a spatial plane E, parallel to the stand surface 16. As a result, the air flow can be directed uniformly and homogeneously across a building floor 93 to be dried in a particularly suitable manner. For this purpose, the guide bodies 6, which are preferably arranged in series, can be adjustable, in particular rotatable, with suitable means being provided to ensure that all guide bodies 6 are adjusted to the same extent by an adjustment of a single guide body 6.

Optionally, lower face outlet openings 5, which can be opened as needed, can be alternatively or additionally provided on the lower face 13, in particular in the region of the stand surface 16, in particular, if necessary. These floor outlet openings 5 make it possible for an air flow to be blown out by the ventilator module 10 directly onto or in the direction of a part of the building against which the ventilator module 10 rests with the lower face 13, in particular a building floor 93, a building wall 94 or a building ceiling 95. Such an air flow can be used, for example, for the drying of screed in which air, which is usually supplied by means of air hoses, is introduced into the sub-floor of the screed through holes or bores made in the screed. To avoid an unwanted secondary flow effect and to improve the stability of the ventilator module 10, sealing bellows 4 can be provided on the lower face 13, as in the present case. The housing base 15 and the stand surface 16 can be formed by the bellows 4. The bellows 4, which are preferably made of rubber, are formed circumferentially on the end face 13a of the lower face 13 and can seal an intermediate space formed between the end face 13a and the building part 93, 94, 95.

As can be seen, in particular in FIG. 4, a particulate filter 74, in particular a HEPA filter, is provided in the region of the inlet opening 11a, 11b of the ventilator module 10, which is not shown in greater detail for clarity purposes. As a result, suspended substances and larger particles occurring in the air 91 can be filtered, which makes it possible to permanently guarantee the functionality of the ventilator module 10, in particular the impeller 14.

The control and/or regulation module 80 shown in more detail in FIG. 7 comprises in this example the detection sensor 81, which protrudes between an air outlet on upper face the module 80, which is not shown in more detail at the top of FIG. 7, and a flow channel 84 for by an air outlet, which is not shown in more detail either, with said sensor being connected to an evaluation module 82, which is formed in the present case as a component. Furthermore, the control and/or regulation module 80 comprises, in the present case, a display and input device 63 which is connected to a computer unit 62. In addition, a communication module 64, a data interface 65 and a GPS module 66 are provided for a remote monitoring or data input, for example. In addition, the control and/or regulation module 80 comprises a circumferential light 67 on the upper face for an optional lighting of a room 90. Like the other system components 10, 20, 30, 40, the control and/or regulation module 80 also comprises a coupling device 61 on the upper face and a counter-coupling device 18 on the lower face. The control and/or regulation module 80 can thus optionally be placed as a module on a ventilator module 10 or another system component 20, 30, 40 and attached thereto. In one operation of the system 100, a preferred structure of interconnected and fastened system components 10, 20, 30, 40, 80 in the order from top to bottom is the control and/or regulation module 80, the air treatment unit 20, 30 and the ventilator module 10.

Of course, the system components not explicitly shown as such in the figures, in particular the evaluation module 82, the display module 63, the communication module 64, the GPS module 66, the light module 67, the accumulator module 73 and the filter module 74, can each be designed as a separate module, which can optionally comprise a coupling and counter-coupling device in order to be coupled to another system component.

It should be clear that the scope of protection of the present invention is not limited to the embodiments described. In particular, the number of system components to be used, as well as their structure and arrangement, are not subject to any limits and can be modified without changing the core of the invention.

### LIST OF REFERENCE SIGNS

1 Operating state
2 Transport state
3 Additional ventilator module
4 Sealing bellows
5 Base outlet opening
6 Guide body
7 Outlet opening
8 Region
9 Housing wall
10 Ventilator module
11 Housing
11a Inlet opening
11b Inlet opening
12 Upper face
12a End/upper face
13 Lower face
13a End/upper face
14 Impeller
14a Motor
15 Housing base
16 Stand surface
17 Coupling device
17a First coupling element
17b Second coupling element
18 Counter-coupling device
18a First counter-coupling element
18b Second counter-coupling element
19 Flow channel
20 Air treatment unit
21 Inlet
22 Outlet
23 Receiving trough
24 Housing, flow channel housing
25 Cooling module
26 Cooling device
27 Condensation body
28 Upper face
29 Lower face
30 Air treatment unit
31 Inlet
32 Outlet
33 Combustion chamber
34 Housing, flow channel housing
35 Heating module
36 Heating device, mini burner
37 Radiator
38 Upper face
39 Lower face
40 Auxiliary module
41 Gas or liquid tank
42 Water hose
42a Pump
43 Water extraction point
44 Upper face
45 Lower face
46 Connection
50 Auxiliary module
51 Heating oil hose
52 Heating oil hose
53 Exhaust hose
54 Connection
55 Connection
61 Coupling device
62 Computing unit
63 Display and input device
64 Communication module
65 Data communication interface
66 GPS module
67 Light, light source, light module
68 Electrical distribution device
69 Plug connection
70 Wall mounting device
71 Support device, strap system
72a Strap
72b Strap
73 Accumulator, accumulator module
74 Particulate filter, filter module
75 Holding plate
80 Control and/or regulation module
81 Detection sensor
82 Evaluation module
83 Electrical line
84 Flow channel
90 Building interior
91 Air
92 Surroundings/ambient conditions
93 Building floor
94 Building wall
95 Building ceiling
100 System
101 Ventilator device
A Rotational axis
S Flow axis/center line
E Level
M Middle

1-35. (canceled)

36. A system for treating air in a building interior, the system comprising at least one ventilator module which comprises:
a housing comprising,
at least one upper face which comprises at least one opening,
a lower face which is arranged opposite to the at least one upper face, the lower face comprising a housing base which is designed as a stand surface for positioning the at least one ventilator module,
at least one housing wall which extends between the at least one upper face and the lower face, and
at least one lateral outlet opening arranged on the at least one housing wall in a region which is adjacent to the lower face;
a flow channel formed in the housing between the at least one upper face and the lower face;
a drive motor arranged in the housing; and
at least one impeller which is configured to rotate about a rotational axis and to be driven by the drive motor so as to convey an air flow between the at least one upper face and the lower face.

37. The system as recited in claim 36, wherein,
the housing base is further designed as the stand surface for positioning the at least one ventilator module in an operating state, and
the at least one lateral outlet opening is further arranged in a region of the housing base so as to blow the air flow in a plurality of directions throughout a room.

38. The system as recited in claim 37, wherein the air flow is further blown in a spatial plane that is parallel to the stand surface.

39. The system as recited in claim 36, wherein the housing base of the at least one ventilator module comprises a base outlet opening which is configured to have the air flow be blown out therethrough substantially perpendicular to the stand surface.

40. The system as recited in claim 36, further comprising:
an air treatment unit comprising a counter-coupling device,
wherein,
the at least one ventilator module further comprises a coupling device and a counter-coupling device,
the at least one ventilator module is provided as a first ventilator module and a second ventilator module, and
the first ventilator module is configured to be releasably connected, via the coupling device, to the counter-coupling device of at least one of the air treatment unit and the second ventilator module.

41. The system as recited in claim 40, wherein the air treatment unit is designed as a cooling module, as a heating module, as a separately designed additional ventilator module, or as a filter module.

42. The system as recited in claim 40, wherein the air treatment unit further comprises a flow channel housing which comprises a flow axis which, when the air treatment unit is coupled to the first ventilator module, is oriented substantially perpendicular to the stand surface of the first ventilator module.

43. The system as recited in claim 40, further comprising:
an auxiliary module which is arranged separately,
wherein,
at least one of the at least one ventilator module and the air treatment unit is at least one of electrically and fluidically connected to the auxiliary module in at least one operating state so as to supply resources or to dispose of the resources.

44. The system as recited in claim 43, further comprising:
a control and/or regulation module comprising at least one detection sensor which is configured to detect at least one of an ambient temperature, an ambient humidity, an ambient movement, an intrinsic movement, an ambient brightness, a connection to an external voltage supply, a battery power, a tank fill level, a removal of a water container, a tensile stress on a support device, a distance to at least one building wall, a distance to at least one building ceiling, a type of installation, and an operating mode, the least one control and/or regulation module being configured to at least one of control and regulate at least one of the at least one ventilator module, the air treatment unit, and the auxiliary module.

45. The system as recited in claim 44, wherein at least one of the ventilator module, the air treatment unit, the auxiliary module, and the control and/or regulation module are at least one of electrically and fluidically connected to one another in an operating state.

46. The system as recited in claim 44, wherein at least one of,
the at least one ventilator module further comprises a communication module which is configured to transmit and to receive data via the Internet,
the air treatment unit further comprises a communication module which is configured to transmit and to receive data via the Internet,
the auxiliary module comprises a communication module which is configured to transmit and to receive data via the Internet, and
the control and/or regulation module further comprises a communication module which is configured to transmit and to receive data via the Internet.

47. The system as recited in claim 44, wherein at least one of,
the at least one ventilator module further comprises a GPS module,
the air treatment unit further comprises a GPS module,
the auxiliary module comprises a GPS module, and
the control and/or regulation module further comprises a GPS module.

48. The system as recited in claim 44, wherein at least one of,
the at least one ventilator module further comprises a support device which is configured to carry the at least one ventilator module,
the air treatment unit further comprises a support device which is configured to carry the air treatment unit,
the auxiliary module comprises a support device which is configured to carry the auxiliary module, and
the control and/or regulation module further comprises a support device which is configured to carry the control and/or regulation module.

49. The system as recited in claim 48, wherein the support device comprises at least two straps.

50. The system as recited in claim 44, wherein at least one of,
the at least one ventilator module further comprises an accumulator which is configured to provide a power supply,
the air treatment unit further comprises an accumulator which is configured to provide a power supply,
the auxiliary module comprises an accumulator which is configured to provide a power supply, and
the control and/or regulation module further comprises an accumulator which is configured to provide a power supply.

51. The system as recited in claim 40, wherein at least one of,
the at least one ventilator module further comprises a light which is configured to light a room, and
the air treatment unit further comprises a light which is configured to light a room, and

52. The system as recited in claim 36, wherein the at least one ventilator module further comprises a wall mounting device arranged in the region which faces the lower face, the wall mounting device being configured to fasten the at least one ventilator module to a building wall.

53. A ventilator device for accelerating air in a building interior, the ventilator device comprising:
a housing comprising,
at least one upper face which comprises at least one opening,
a lower face which is arranged opposite to the at least one upper face, the lower face comprising a housing base which is designed as a stand surface for positioning the at least one ventilator module,
at least one housing wall which extends between the at least one upper face and the lower face, and
at least one lateral outlet opening arranged on the at least one housing wall in a region which is adjacent to the lower face;
a flow channel formed in the housing between the at least one upper face and the lower face;
a drive motor arranged in the housing; and
at least one impeller which is configured to rotate about a rotational axis and to be driven by the drive motor so as to convey an air flow between the at least one upper face and the lower face.

54. The system as recited in claim 36, wherein,
the housing base is further designed as the stand surface for positioning the at least one ventilator module in an operating state, and
the at least one lateral outlet opening is further arranged in a region of the housing base so as to blow the air flow in a plurality of directions throughout the room.
